(19) United States
(12) Patent Application Publication
(10) Pub. No.: US 2011/0320117 A1
(43) Pub. Date: Dec. 29, 2011

(54) NAVIGATION SYSTEM

(76) Inventors: Tsuyoshi Sempuku, Tokyo (JP); Shoji Tanaka, Tokyo (JP); Masato Hirai, Tokyo (JP); Hideto Miyazaki, Tokyo (JP); Kuniyo Ieda, Tokyo (JP); Takashi Sadahiro, Tokyo (JP)

(21) Appl. No.: 13/202,342

(22) PCT Filed: Mar. 26, 2010
(86) PCT No.: PCT/JP2010/002203

§ 371 Date: Aug. 19, 2011

(30) Foreign Application Priority Data
Mar. 27, 2009 (JP) 2009-079578

(51) Int. Cl. G01C 21/00

(52) U.S. Cl. 701/201

(57) ABSTRACT

Including a vehicle position determining unit (4, 6, 7, 11) for determining current position of a mobile unit; a map DB 15 that stores map data; a display unit 18 for displaying on its screen the map data and a vehicle mark indicating the position of the mobile unit on a map; an operation input unit 10 for inputting a user operation; a route searching unit 12 for searching for a route to a destination or a route to the destination via a spot on the route; and a map generating unit 17. When the map on the screen moves in response to operation information from the operation input unit 10, the map generating unit reads the map data from the map DB 15, generates a general map including the current position and vehicle mark, and displays it on the display unit 18 as a partial area in the screen.

### TECHNICAL FIELD

The present invention relates to a navigation system mounted in a mobile unit for displaying a map or directing it to its destination.

### BACKGROUND ART

When a registered memory spot is selected on a conventional car navigation system, it displays the current position of a vehicle and a road map around it, alters the road map to a wide-area small-scale map, and automatically scrolls it from the current position toward the memory spot or the like. Then, it alters a road map around the memory spot or the like into a large-scale map and displays it. Thus, a user can grasp a positional relationship between the current position and the memory spot or the like, and an approximate distance (see Patent Document 1, for example).

### PRIOR ART DOCUMENT

### Patent Document

Patent Document 1: Japanese Patent Laid-Open No. 2004-108894 (pp. 5-7 and FIG. 2).

### DISCLOSURE OF THE INVENTION

The conventional car navigation system has a problem in that it is difficult to understand the positional relationship and to perceive the distance because the automatic scrolling is sometimes made in such a manner that the map displayed does not include the current position concurrently at the scrolling toward the memory spot registered.

The present invention is implemented to solve the foregoing problem. Therefore it is an object of the present invention to provide a navigation system capable of facilitating the understanding of the relationship with the current position during the movement of a map.

A navigation system in accordance with the present invention includes a vehicle position determining unit for determining a current position of a mobile unit; a map database that stores map data; a display unit for displaying on its screen the map data and a vehicle mark indicating the position of the mobile unit on the map; an operation input unit for inputting operation of a user; a route searching unit for searching for a route to a destination or a route to the destination via a spot on the route; and a map generating unit. The map generating unit reads the map data from the map database, generates a general map including the current position and the vehicle mark, and displays the general map on the display unit as a partial area in the screen, when the map on the screen moves in response to operation information from the operation input unit.

According to the present invention, when the map on the screen moves in response to the user operation, the general map including the current position and the vehicle mark is displayed. Accordingly, a navigation system capable of facilitating the understanding of the relationship with the current position is obtained.

### BRIEF DESCRIPTION OF THE DRAWINGS

FIG. 1 is a block diagram showing a navigation system of embodiments 1-14 in accordance with the present invention;

FIG. 2 is a block diagram showing a functional configuration of the embodiments 1-4 in accordance with the present invention;

FIG. 3 is a flowchart showing the operation of the embodiment 1 in accordance with the present invention;

FIG. 4 is an example of screen display showing the embodiment 1 in accordance with the present invention;

FIG. 5 is a flowchart showing the operation of the embodiment 2 in accordance with the present invention;

FIG. 6 is an example of screen display showing the embodiment 2 in accordance with the present invention;

FIG. 7 is a flowchart showing the operation of the embodiment 3 in accordance with the present invention;

FIG. 8 is an example of screen display showing the embodiment 3 in accordance with the present invention;

FIG. 9 is a flowchart showing the operation of the embodiment 4 in accordance with the present invention;

FIG. 10 is an example of screen display showing the embodiment 4 in accordance with the present invention;

FIG. 11 is a block diagram showing a functional configuration of the embodiments 5-14 in accordance with the present invention;

FIG. 12 is a flowchart showing the operation of the embodiment 5 in accordance with the present invention;

FIG. 13 is an example of screen display showing the embodiment in accordance with the present invention;

FIG. 14 is a flowchart showing the operation of the embodiment 6 in accordance with the present invention;

FIG. 15 is an example of screen display showing the embodiment 6 in accordance with the present invention;

FIG. 16 is a flowchart showing the operation of the embodiment 7 in accordance with the present invention;

FIG. 17 is an example of screen display showing the embodiment 7 in accordance with the present invention;

FIG. 18 is a flowchart showing the operation of the embodiment 8 in accordance with the present invention;

FIG. 19 is an example of screen display showing the embodiment 8 in accordance with the present invention;

FIG. 20 is a flowchart showing the operation of the embodiment 9 in accordance with the present invention;

FIG. 21 is an example of screen display showing the embodiment 9 in accordance with the present invention;

FIG. 22 is a flowchart showing the operation of the embodiment 10 in accordance with the present invention;

FIG. 23 is an example of screen display showing the embodiment 10 in accordance with the present invention;

FIG. 24 is a flowchart showing the operation of the embodiment 11 in accordance with the present invention;

FIG. 25 is an example of screen display showing the embodiment 11 in accordance with the present invention;

FIG. 26 is an example of screen display showing the embodiment 12 in accordance with the present invention;

FIG. 27 is an example of screen display showing the embodiment 13 in accordance with the present invention; and

FIG. 28 is an example of screen display showing the embodiment 14 in accordance with the present invention.

### EMBODIMENTS FOR CARRYING OUT THE INVENTION

The embodiments for carrying out the invention will now be described with reference to the accompanying drawings to explain the present invention in more detail.

### Embodiment 1

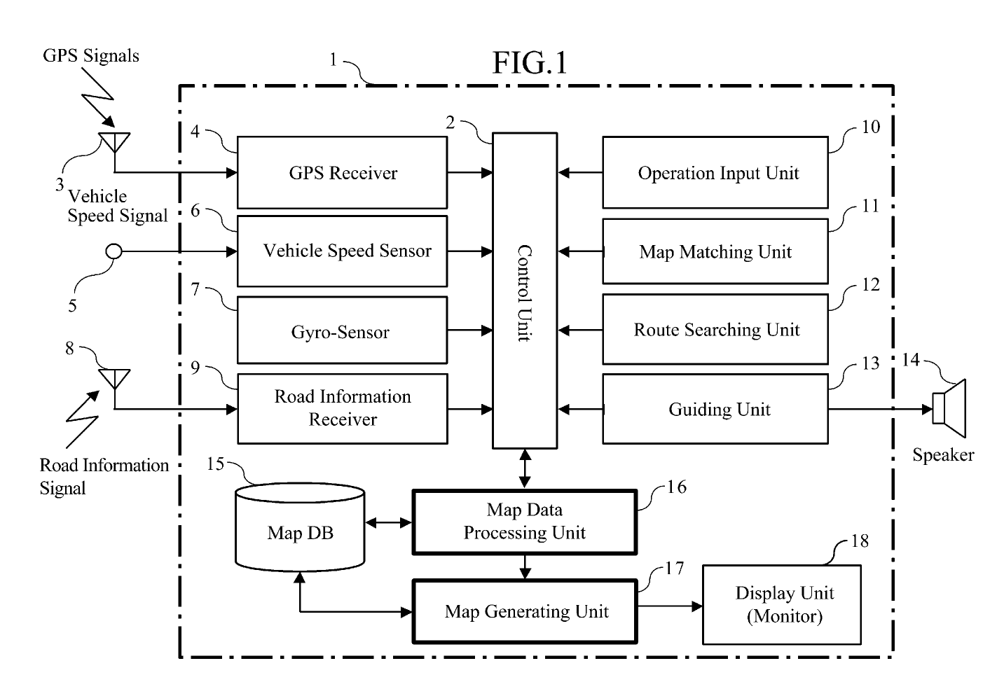

FIG. 1 is a block diagram showing a navigation system of an embodiment 1 in accordance with the present invention. A control unit 2 in the navigation system 1 is composed of a microcomputer, for example, and controls the system in its entirety. A GPS (Global Positioning System) receiver 4 receives GPS signals from GPS satellites via a GPS receiving antenna 3, and detects the current position of the vehicle according to the signals. An input terminal 5 of a vehicle speed signal receives a vehicle speed signal of a mobile unit such as a vehicle in which the navigation system 1 is mounted, and a vehicle speed sensor 6 detects traveling speed of the mobile unit from the vehicle speed signal. A gyro-sensor 7 detects the direction of travel of the mobile unit. A road information receiver 9 receives a road information signal such as on congestion or regulation from an FM broadcast wave, radio beacon or optical beacon via a road information receiving antenna 8.

An operation input unit 10 receives operation of a user from a control panel or remote control not shown. A map matching unit 11 matches the current position, which is created from the current position data from the GPS receiver 4, the speed data delivered from the vehicle speed sensor 6 and the direction data delivered from the gyro-sensor 7, to a map formed by map data readout of a map data processing unit 16 which will be described later, and determines the current position of the mobile unit. The GPS receiver 4, vehicle speed sensor 6, gyro-sensor 7 and map matching unit 11 constitute a vehicle position determining unit.

A route searching unit 12 searches for a route from a starting point, set point, current position or the like of the mobile unit to a destination or a route to a destination via a spot on the route. A guiding unit 13 forms a guide map and a voice guide message to be output when the mobile unit travels along the route searched by the route searching unit 12. A speaker 14 outputs the guide message delivered from the guiding unit 13 in voice. A map DB (Data Base) 15 stores data such as map data, facility data and programs for controlling individual functions in the navigation system 1. It comprises an HDD (Hard Disk Drive) or the like, for example.

The map data processing unit 16 temporarily keeps the map data delivered from the map DB 15, and processes the association of the data, such as the current position data delivered from the map matching unit 11 and the route data delivered from the route searching unit 12, with the map data via the control unit 2. A map generating unit 17 generates a display signal to be displayed on a display unit 18 in response to the data delivered from the map data processing unit 16. In the course of this, it acquires a variety of data from the map DB 15.

The display unit 18 such as a monitor is composed of an LCD (Liquid Crystal Display) and displays on its screen the map data, a vehicle mark indicating the position of a vehicle on the map, the route searched, and a variety of other messages in response to the display signal delivered from the map generating unit 17. On the screen of the monitor, the picture that displays the map data in the maximum scale is considered a main window, and it becomes a map display picture displaying the map. In addition, a subwindow is sometimes formed on part of the screen of the monitor, and it becomes a picture displaying a general map and various information items. Incidentally, although the general map usually displays a wide area by making the scale smaller than that of the map in the main window, when the amount of movement of the map by scrolling or the like is small, the general map can be displayed on the same scale as that of the map in the main window or on an increased scale.

Incidentally, as for the antenna 3, antenna 8 and speaker 14, although the navigation system 1 uses those equipped for the mobile unit, the navigation system 1 can include them.

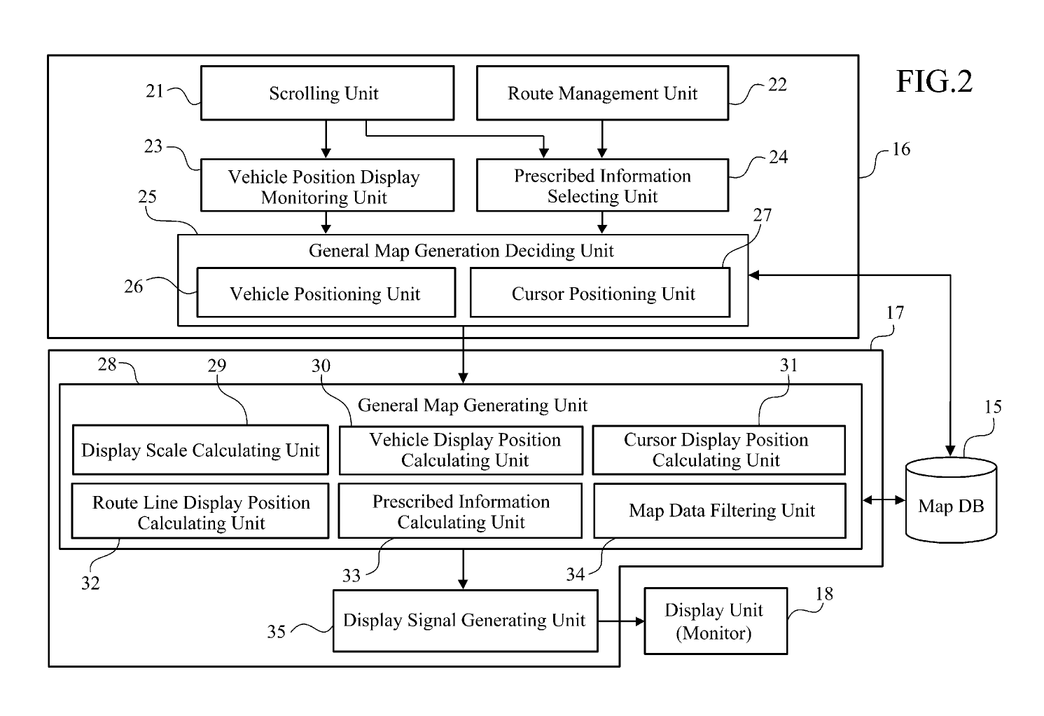

FIG. 2 is a block diagram showing a detailed functional configuration of the map data processing unit 16 and map generating unit 17 of FIG. 1. The map data processing unit 16 comprises a scrolling unit 21, a route management unit 22, a vehicle position display monitoring unit 23, a prescribed information selecting unit 24 and a general map generation deciding unit 25. In addition, the map generating unit 17 comprises a general map generating unit 28 and a display signal generating unit 35.

The scrolling unit 21 outputs a cursor position corresponding to the user operation such as scrolling in response to the operation signal from the control panel of the operation input unit 10 or from a remote control via the control unit 2. According to the current position via the control unit 2 and to the information from the scrolling unit 21, the vehicle position display monitoring unit 23 monitors the current position of the vehicle displayed at a prescribed position in the main window on the screen (the position at which it is normally displayed on the screen such as at the center of the screen or at a lower part of the central portion). According to the information from the scrolling unit, it monitors as to whether the current position of the vehicle moves from the prescribed position in the main window on the screen or to the outside of the map in the main window with the movement of the map.

The route management unit 22 outputs the presence or absence of a route setting in accordance with the route information from the route searching unit 12 via the control unit 2. According to the current position via the control unit 2, the cursor position from the scrolling unit 21 and the information from the route management unit 22, the prescribed information selecting unit 24 selects, determines and outputs prescribed information to be displayed on the general map in the subwindow (such as the current position of the vehicle and the cursor position, and when the route is set, such information as the current position and destination, and information about the current position to the destination via a spot on the route).

The general map generation deciding unit 25 comprises a vehicle positioning unit 26 and a cursor positioning unit 27, and refers to the map DB 15 as needed. The vehicle positioning unit 26 specifies the movement of the current position of the vehicle on the map in accordance with the information from the vehicle position determining unit such as the GPS, gyro, vehicle speed, and map matching via the control unit 2. The cursor positioning unit 27 specifies the movement of the cursor position on the map from the map data from the map DB 15. In response to the movements on the map, to the presence or absence of the movement of the current position of the vehicle in the main window from the vehicle position display monitoring unit 23, and to the prescribed information such as the spot on the route and destination from the prescribed information selecting unit, the general map generation deciding unit 25 makes a decision as to whether the current position of the vehicle or the destination in the main window on the screen moves with the movement of the map by the user operation such as scrolling, or moves to the outside of the display area of the map on the screen, that is, moves to the outside of the main window, and decides whether to generate the general map in the subwindow.

The general map generating unit 28 in the map generating unit 17 comprises a display scale calculating unit 29, a vehicle display position calculating unit 30, a cursor display position calculating unit 31, a route line display position calculating unit 32, a prescribed information calculating unit 33, and a map data filtering unit 34, which will be described later, generates data required for drawing the general map in the subwindow from the information from the general map generation deciding unit 25 of the map data processing unit 16, and supplies the data to the display signal generating unit 35. In the course of this, it refers to the map DB 15 as needed. The display signal generating unit 35 combines the map display picture in the main window and the general map picture in the subwindow, and supplies the display signal to the display unit 18 to be displayed.

The display scale calculating unit 29 calculates the scale of the map so that the current position of the vehicle and the cursor position are included in the general map display area in the subwindow. The vehicle display position calculating unit 30 calculates the vehicle display position on the general map. The cursor display position calculating unit 31 calculates the cursor display position on the general map. The route line display position calculating unit 32 calculates the display position of the route on the general map. The prescribed information calculating unit 33 calculates prescribed information such as the distance and the time taken between the current position of the vehicle and the cursor position or the like. The map data filtering unit 34 removes unnecessary data for creating a simple general map, such as icons representing facilities and narrow roads.

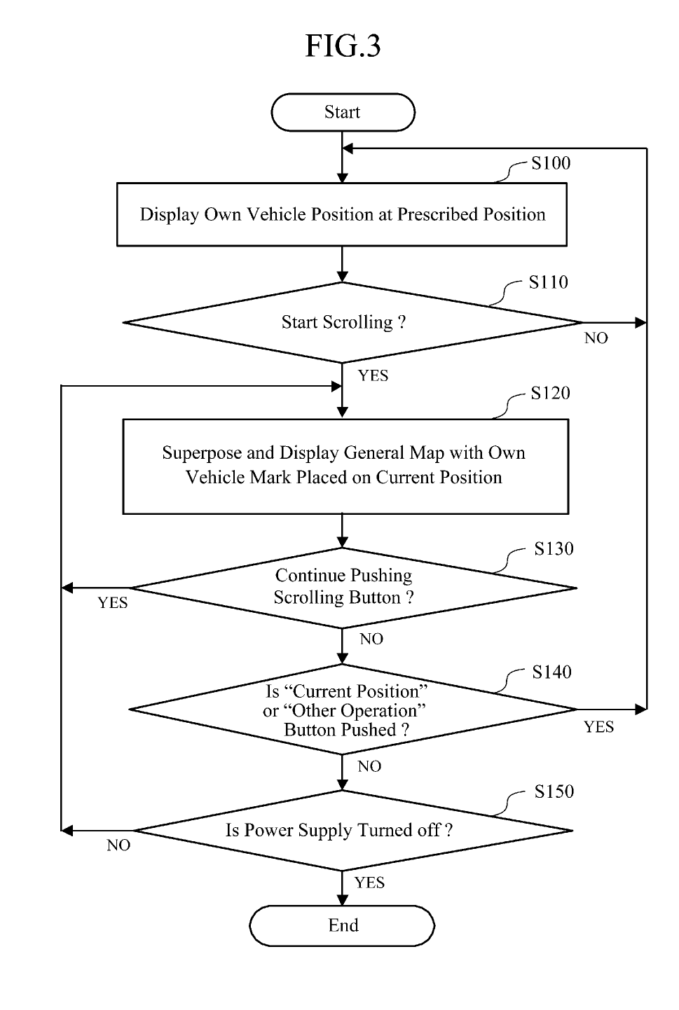

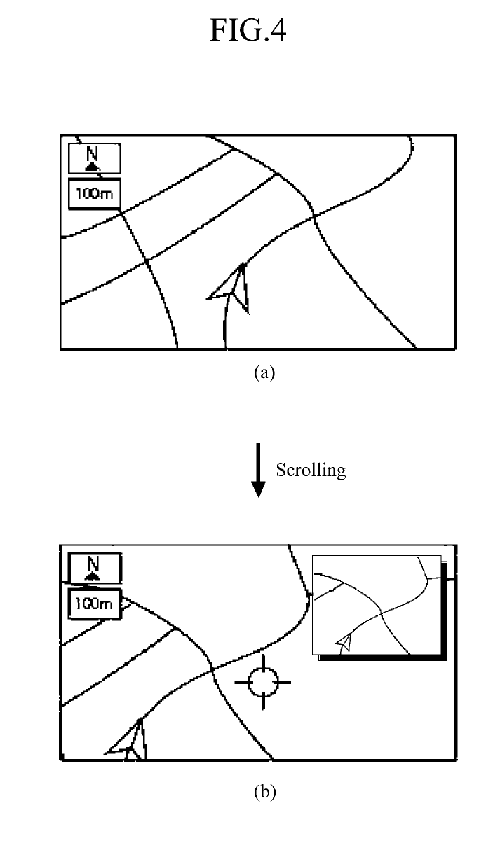

The operation of the navigation system with the foregoing configuration will be described with reference to the flowchart of FIG. 3. In addition, FIG. 4 shows screen display examples at that time. As shown in FIG. 4(a), when operating the navigation system 1, the navigation system 1 places on the current position the vehicle mark which indicates on the map the position of the mobile unit in which the navigation system 1 is mounted (in FIG. 4(a), a triangle-like symbol near the central portion on the screen is the vehicle mark whose tip indicates the current position), and displays it at the prescribed position on the map display picture in the main window (normally displayed position on the screen such as at the lower part of the central portion on the screen) (step S100).

Next, the scrolling unit 21 checks whether scrolling is started or not (step S110). When the scrolling is not started, the processing returns to step S100 to continue the display of the current position of the vehicle. When a decision is made that the scrolling is started and the map in the main window starts moving, a circle-like cursor mark is displayed near the central portion in the main window on the screen as shown in FIG. 4(b), and the general map showing the vehicle mark placed on the current position of the vehicle is formed in the subwindow, and the subwindow is superposed and displayed on the map display picture in the main window (step S120). In this case, among the functions of the map generating unit 17 concerning the general map creation, the display scale calculating unit 29, map data filtering unit 34 and display signal generating unit 35 operate for creating the general map.

Next, the scrolling unit 21 makes a decision as to whether the scroll button is being pushed to continue the scrolling (step S130). When the scrolling is continued, the processing returns to step S120 at which the display scale calculating unit 29 right sizes the display scale of the general map picture to continue the superposition display. In contrast, when the scrolling is stopped, the scrolling unit 21 makes a decision as to whether other operation is carried out or not according to a “current position” or “other operation” button (step S140).

When some other operation is carried out, the subwindow is turned off, and the processing proceeds to step S100 to display the current position of the vehicle at the prescribed position in the map display picture in the main window on the screen. If no other operation is carried out, a decision is made as to whether the power supply of the navigation system 1 is turned off or not (step S150). If the power supply is turned off, the processing is terminated. Unless the power supply is turned off, the processing returns to step S120 at which the scrolling is placed in a pause mode and the map is displayed in the subwindow continuously. Incidentally, if the scroll button is pushed again at step S130, the scrolling is restarted.

In the navigation system with such a configuration, when the user starts scrolling by his or her operation and the map in the main window on the screen moves, the general map including the current position of the vehicle and the vehicle mark is displayed in the subwindow. This can implement a navigation system capable of facilitating the understanding of the relationships of the direction and distance to the current position of the vehicle during the scrolling. In addition, this makes it possible to scroll to any desired position or to change scrolling to another position in the course of the scrolling. Furthermore, this makes it possible to restart the scrolling after stopping the picture during scrolling and confirming the map around it, thereby offering a more convenient navigation system.

### Embodiment 2

Although the embodiment 1 displays in the subwindow the general map including the vehicle mark on the current position, the present embodiment 2 explains a navigation system that displays on the general map the cursor position at the scrolling to facilitate the understanding of the positional relationship.

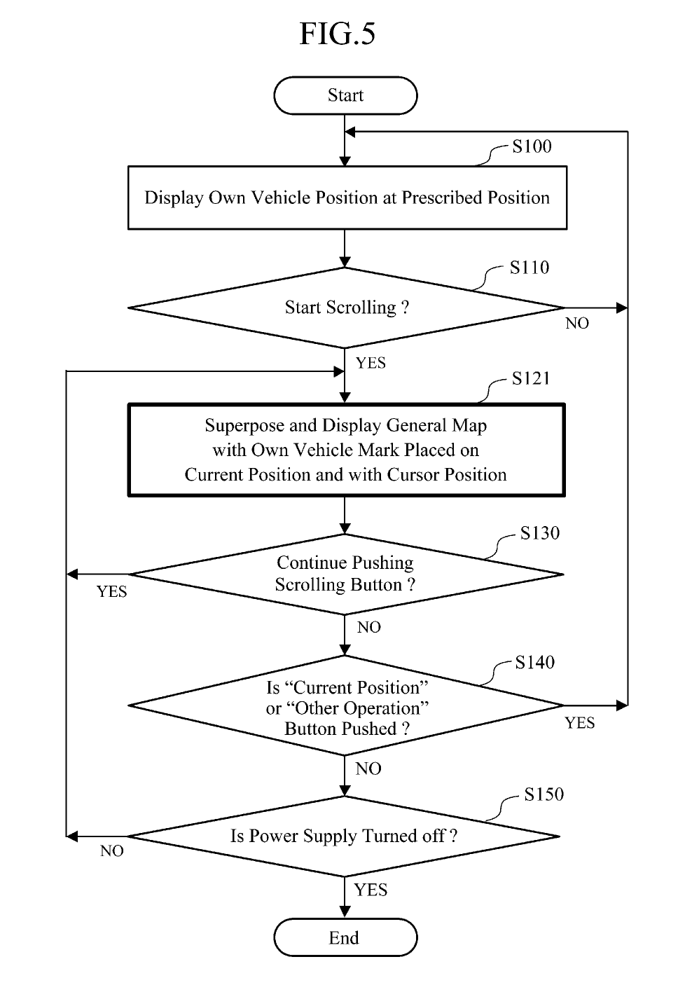

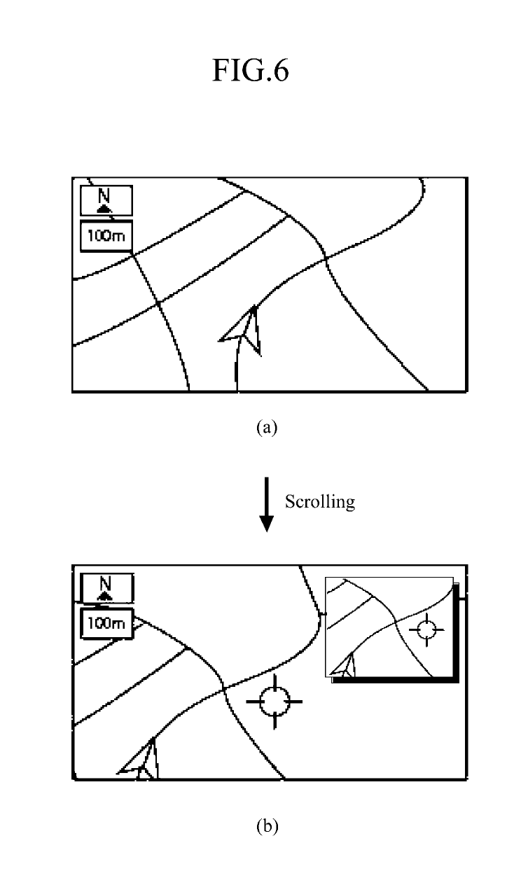

As for the system configuration, it is the same as the block diagrams of FIG. 1 and FIG. 2. FIG. 5 is a flowchart for explaining the present embodiment 2, and FIG. 6 is an example of screen display. It differs from the embodiment 1 in step S121 of FIG. 5 and in the screen display of FIG. 6(b). These differences will be described below.

When scrolling is started and the map in the main window moves, and when the general map picture in the subwindow is superposed and displayed on the map display picture in the main window, the subwindow displays as shown in FIG. 6(b) the general map picture including not only the vehicle mark placed on the current position of the vehicle but also the cursor position (in FIG. 6(b), the cursor is the circle-like mark near the central portion in the picture) (step S121 in FIG. 5). They are obtained by operating the vehicle display position calculating unit 30 and the cursor display position calculating unit 31 of FIG. 2.

In the navigation system with such a configuration, the current position of the mobile unit represented by the vehicle mark and the cursor position during scrolling are displayed at the same time. This can facilitate the understanding of the relationships of the position and distance of the scrolling to the current position, thereby offering a more convenient navigation system.

### Embodiment 3

Although the embodiment 2 displays in the subwindow the general map including both the vehicle mark placed on the current position and the cursor position, the present embodiment 3 explains a navigation system that facilitates the understanding of the positional relationships by further displaying information such as about a distance and the time required on the general map in the subwindow.

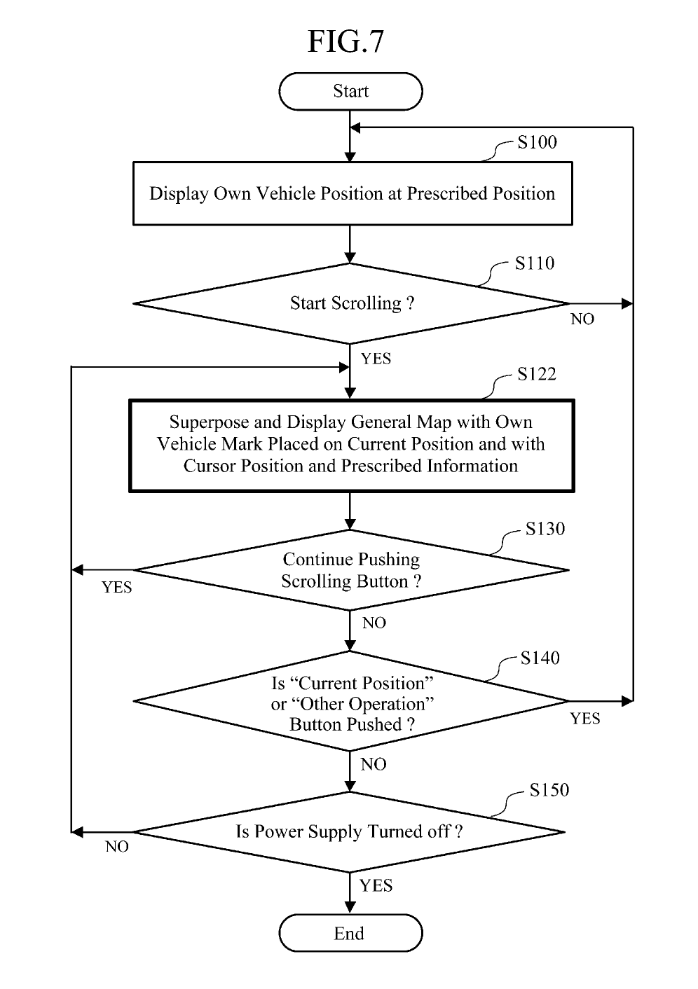

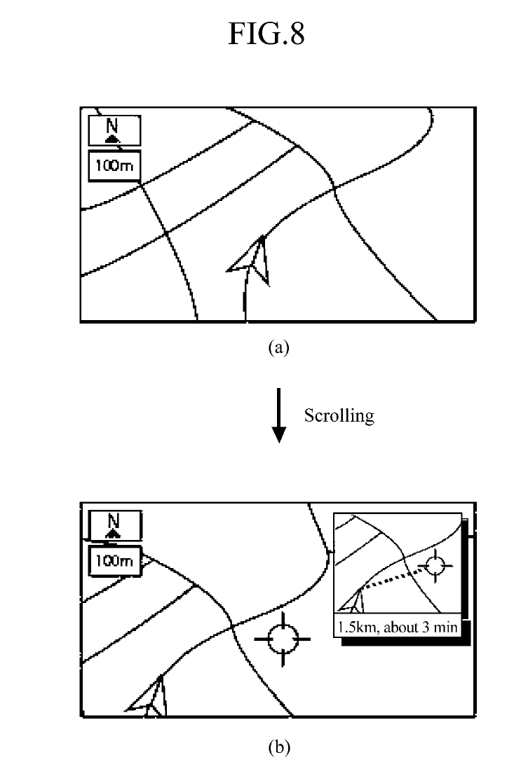

As for the system configuration, it is the same as the block diagrams of FIG. 1 and FIG. 2. FIG. 7 is a flowchart for explaining the present embodiment 3, and FIG. 8 is an example of screen display. It differs from the embodiment 2 in step S122 of FIG. 7 and a screen display of FIG. 8(b). These differences will be described below.

When scrolling is started and the map in the main window moves, and when the general map picture in the subwindow is superposed and displayed on the map display picture in the main window, the subwindow displays as shown in FIG. 8(b) prescribed information (such as a direct distance and the time required between the current position of the vehicle and the cursor position) additionally on the general map picture including the vehicle mark on the current position and the cursor position (step S122 of FIG. 7). The distance and the time required and the like are obtained by applying operation of the prescribed information calculating unit 33 in the map generating unit 17 to the objects selected by the prescribed information selecting unit 24 in the map data processing unit 16 of FIG. 2. Incidentally, connecting the current position of the vehicle to the cursor position by a dotted line or a line with a different color as shown in the subwindow of FIG. 8(b) will facilitate the understanding.

The navigation system with such a configuration can facilitate the understanding of the information such as about the distance and the time required between the current position of the vehicle and the cursor position, thereby offering a more convenient navigation system. In addition, when setting the cursor position at the destination or a spot on the route, it enables the user to grasp the prescribed information such as the distance and time to that place before setting a new route, thereby offering a user-friendly navigation system.

### Embodiment 4

Although the embodiment 2 displays in the subwindow the general map including the vehicle mark on the current position and the cursor, the present embodiment 4 explains a navigation system that reduces the amount of information about the general map and displays a simplified map, thereby facilitating the understanding of the positional relationships.

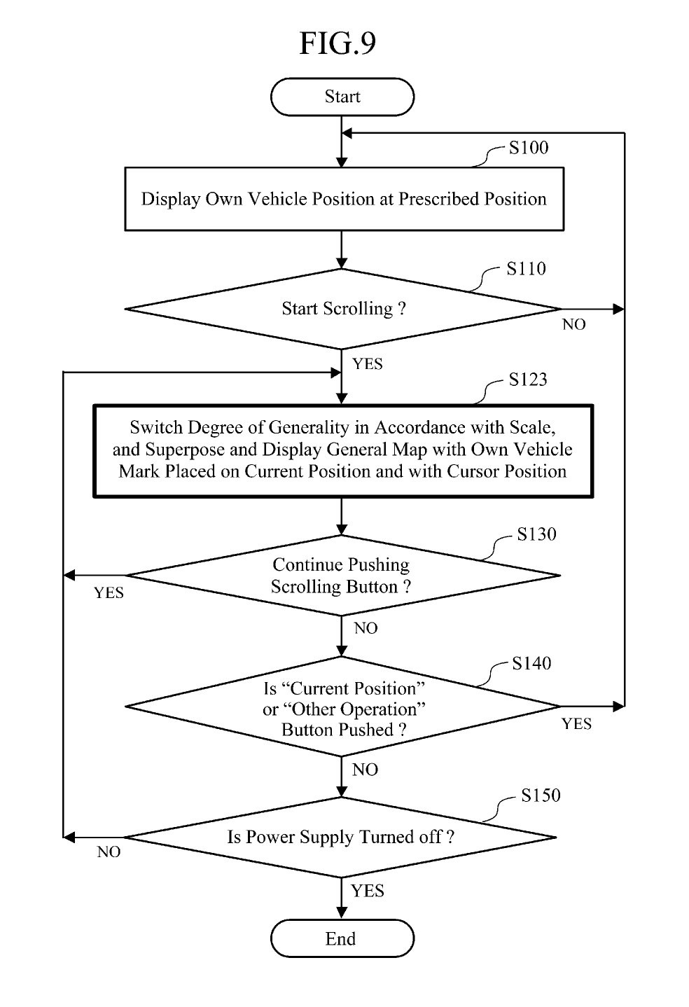

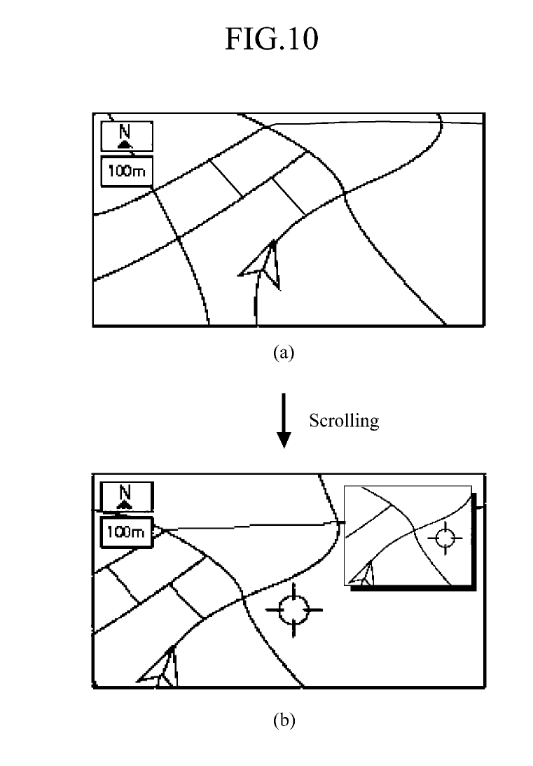

As for the system configuration, it is the same as the block diagrams of FIG. 1 and FIG. 2. FIG. 9 is a flowchart for explaining the present embodiment 4, and FIG. 10 shows an example of screen display. It differs from the embodiment 2 in step S123 of FIG. 9 and a screen display of FIG. 10. These differences will be described below.

When scrolling is started and the map in the main window moves, and when the general map picture in the subwindow is superposed and displayed on the map display picture in the main window, the subwindow displays as shown in FIG. 10(b) a simplified general map with the same scale but with the amount of information less than that of the general map, or displays a map simplified in accordance with the scale of the general map (step S123 in FIG. 9). For example, as the map becomes a wider-area map with a smaller scale, the amount of information is reduced by omitting narrow roads and the like to simplify and facilitate the understanding. Incidentally, this is achieved by applying the operation of the map data filtering unit 34 to the information in the display scale calculating unit 29 of FIG. 2.

In the map display device with such a configuration, when the distance between the current position of the mobile unit and the cursor position becomes distant and the map becomes a wider-area map with a smaller scale, it employs a simpler map (such as a line drawing with only the running route), thereby being able to implement a navigation system capable of displaying a map that facilitates the understanding of the positional relationship.

### Embodiment 5

Although the embodiments 1-4 display the general map including the vehicle mark on the current position and the like in the subwindow when neither a destination nor a route is set, the present embodiment 5 explains a navigation system capable of facilitating, when a route to a destination is set, the understanding of positional relationships by displaying the destination on the general map.

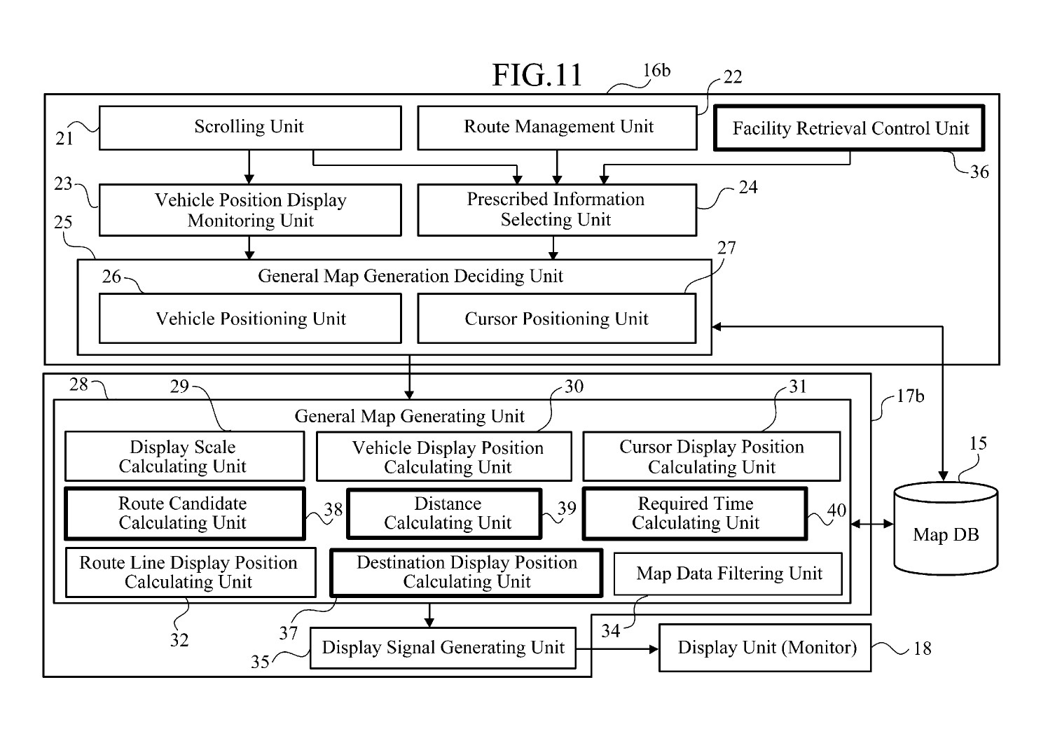

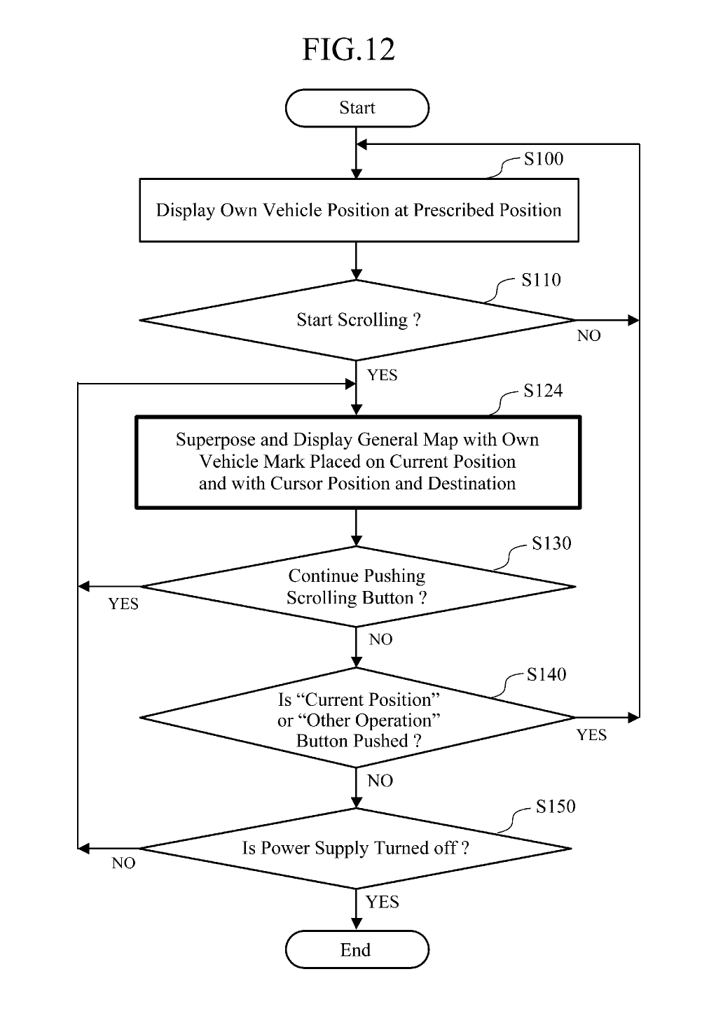

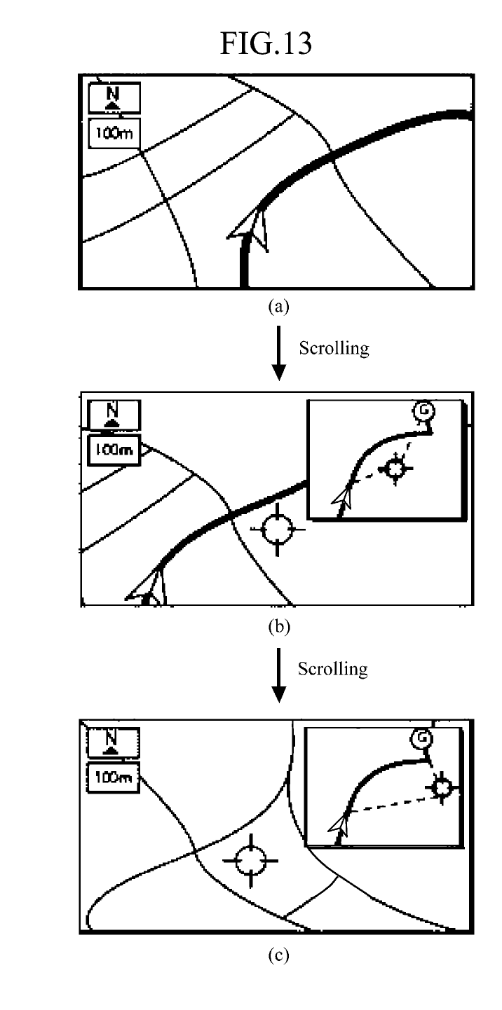

The system configuration is the same as the block diagram of FIG. 1. FIG. 11 is a block diagram showing a functional configuration of the present embodiment. FIG. 12 is a flowchart for explaining the present embodiment 5, and FIG. 13 shows an example of screen display. It differs from the embodiment 2 in FIG. 11, in step S124 of FIG. 12 and in the screen display of FIG. 13. These differences will be described below.

Referring to FIG. 11, different portions from the functional configuration of FIG. 2 will be described. A facility retrieval control unit 36 in the map data processing unit 16 outputs whether a map displays facilities, spots and the like extracted by retrieval. A destination display position calculating unit 37 calculates locations at which the destination, a spot on the route, a prescribed target position on the route (an intersection that turns in the route, a position at which the number of lanes alters in the route, a facility whose distance from the route is not greater than a prescribed value, roads, intersections and typical points such as landmarks) are positioned on the map.

A route candidate calculating unit 38 in the general map generating unit 28 calculates a route candidate and its drawing data from the current position of the vehicle to the cursor position or to a representative spot (such as a facility, road, intersection and landmark) within a prescribed distance from the cursor position. In addition, it calculates a route candidate and its drawing data passing through the position of a facility or spot extracted by the retrieval or through the cursor position or a representative spot within a prescribed distance from the cursor position. A distance calculating unit 39 calculates a direct distance between the current position of the vehicle, the destination, a spot on the route such as a facility and a spot extracted by the retrieval, a prescribed target position on the route, the cursor position and a representative spot within a prescribed distance from the cursor position, or a route distance along the route candidate fed from the route candidate calculating unit 38. A required time calculating unit 40 calculates the estimated time required from the direct distance or route distance fed from the distance calculating unit 39. Incidentally, the distance calculating unit 39 and the required time calculating unit 40 correspond to a division of the prescribed information calculating unit 33 of FIG. 2.

In the navigation system with such a configuration, a triangle-like vehicle mark and a route represented by a bold line are displayed in the main window as shown in FIG. 13(a). Here, when scrolling is started and the map in the main window moves, and when the general map picture in the subwindow is superposed and displayed on the map display picture in the main window, the subwindow displays as shown in FIGS. 13(b) and 13(c) the general map picture including, in addition to the vehicle mark on the current position and the cursor position, the destination denoted by “G” in the drawing and the route set to the destination (step S124 in FIG. 12). The display position of the destination is obtained by operating the destination display position calculating unit 37. Incidentally, the display of the route can be omitted.

Incidentally, although the subwindow displays the destination here, it can display, instead of the destination, a spot on the route, an intersection at which to make a turn, an interchange, a spot where the number of lanes changes, a representative spot within a prescribed distance from the route (such as a facility, road, intersection and landmark).

The navigation system with such a configuration can offer a navigation system capable of displaying a map that can facilitate the understanding of the positional relationships inclusive of the current position of the mobile unit, the cursor position, the destination and the like, thereby being able to improve its convenience.

### Embodiment 6

Although the embodiment 5 displays the general map including the vehicle mark on the current position, the cursor and the destination in the subwindow, the present embodiment 6 explains a navigation system capable of further facilitating the understanding of circumstances of the cursor position by displaying prescribed information on the general map in the subwindow.

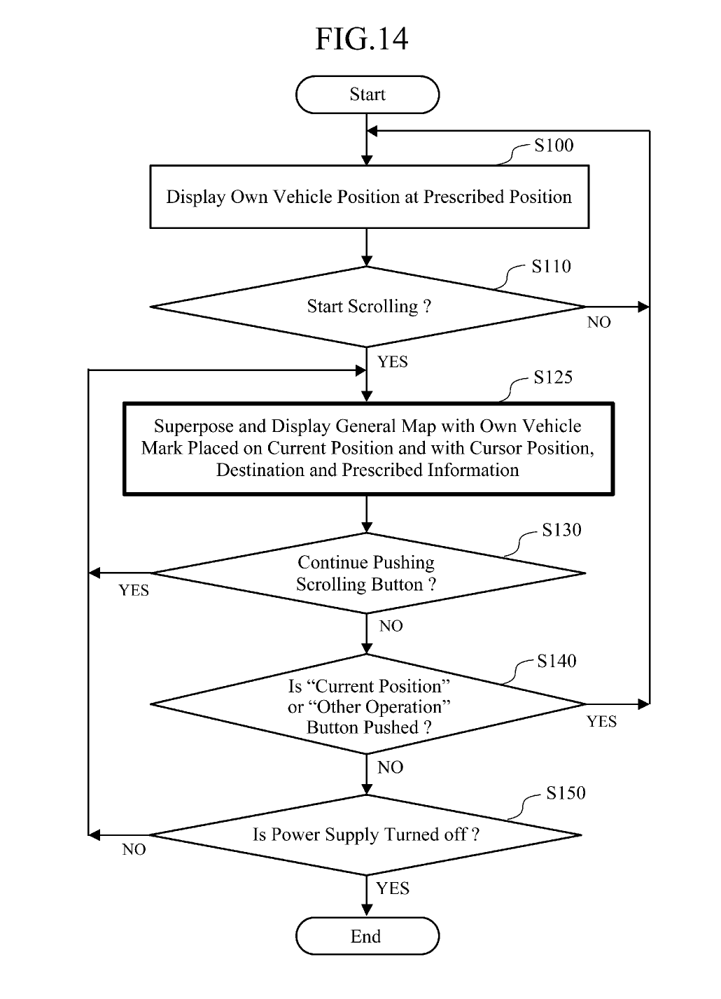

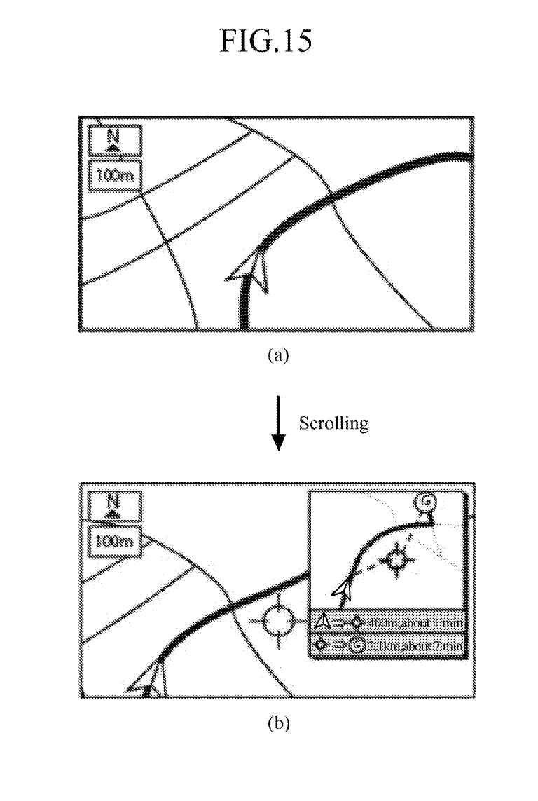

As for the system configuration, it is the same as the block diagrams of FIG. 1 and FIG. 11. FIG. 14 is a flowchart for explaining the present embodiment, and FIG. 15 is an example of screen display. It differs from the embodiment 5 in step S125 of FIG. 14 and the screen display of FIG. 15(b). These differences will be described below.

When scrolling is started and the map in the main window moves, and when the general map picture in the subwindow is superposed and displayed on the map display picture in the main window, the subwindow displays as shown in FIG. 15(b) the general map picture including the prescribed information in addition to the vehicle mark on the current position, the cursor position and the destination (step S125 in FIG. 14). As the prescribed information, there are such information items as the direct distance and the time required between the current position of the vehicle and the cursor position, and between the cursor position and the destination. Incidentally, they are obtained by operating the distance calculating unit 39 and the required time calculating unit 40 of FIG. 11.

The navigation system with such a configuration offers a navigation system that is capable of facilitating the understanding and comparison of the circumstances around the cursor position and is superior in convenience because it displays not only the route that has already been set from the position of the mobile unit to the position of the destination, but also the prescribed information to the cursor position.

### Embodiment 7

Although the embodiment 6 displays in the subwindow the general map including the vehicle mark on the current position, the cursor, the destination and the prescribed information about the cursor position, the present embodiment 7 explains a navigation system that can easily set a new route by displaying on the general map the new route passing through the cursor position and by displaying prescribed information about the new route.

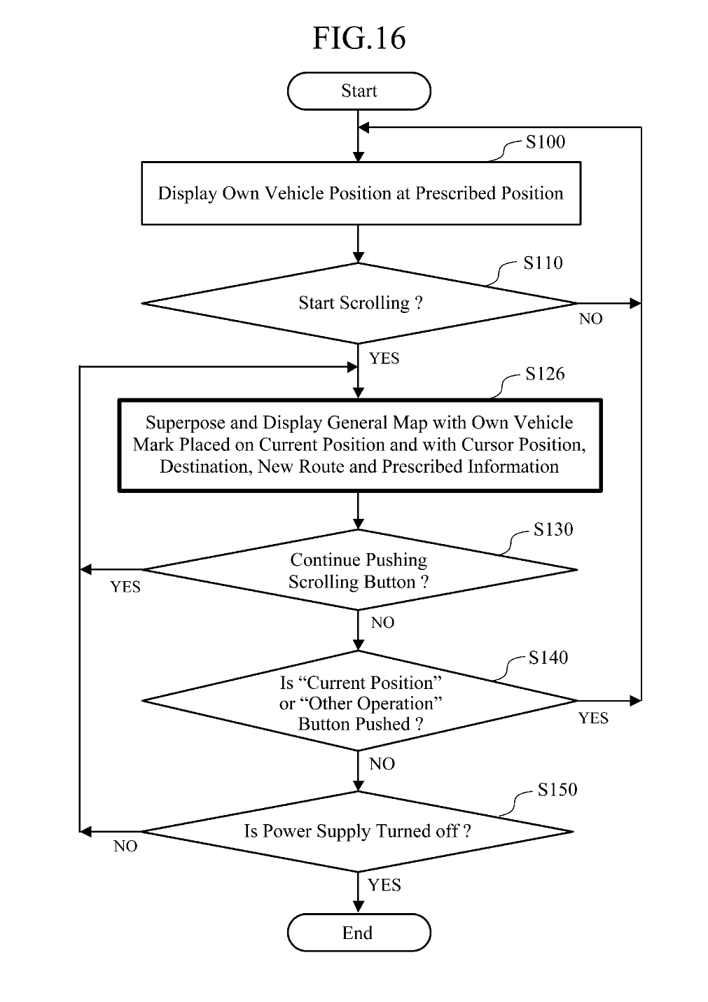

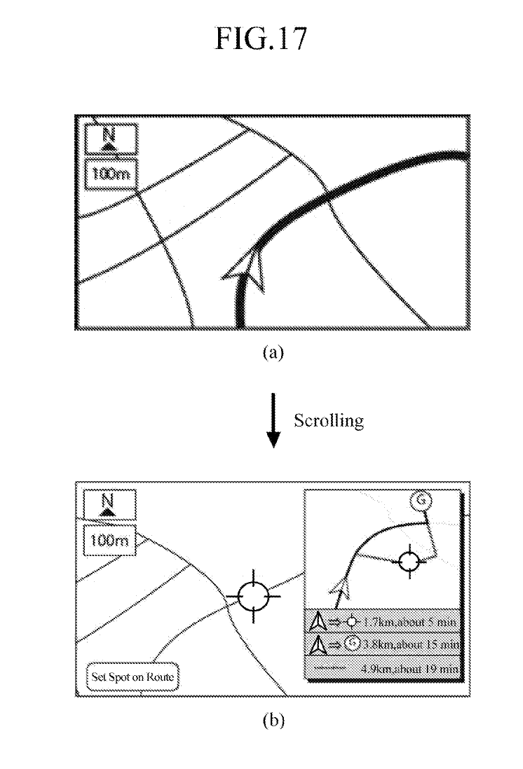

As for the system configuration, it is the same as the block diagrams of FIG. 1 and FIG. 11. FIG. 16 is a flowchart for explaining the present embodiment 7, and FIG. 17 is an example of screen display. It differs from the embodiment 6 in step S126 of FIG. 16 and the screen display of FIG. 17(b). These differences will be described below.

When scrolling is started and the map in the main window moves, and when the general map picture in the subwindow is superposed and displayed on the map display picture in the main window, the subwindow displays as shown in FIG. 17(b) the general map picture including, in addition to the vehicle mark on the current position, the cursor position and the destination, the new route passing through the cursor position and the prescribed information about the new route (step S126 in FIG. 16). In FIG. 17(b), it displays mutual information between the current position and cursor position and between the current position and destination (information on the distance and time required about the route), and route information from the current position to the destination via the cursor position (information on the distance and time required about the new route).

As for the new route, if there is not an actually passable road on the cursor position or if there is not a road on the cursor position or if a road is impassable because of one-way traffic, the route candidate calculating unit 38 of FIG. 11 selects an actually passable road within a prescribed distance from the cursor position and sets the route, and the distance calculating unit 39 and the required time calculating unit 40 obtain the prescribed information from the information. Incidentally, if the cursor position is on a mountain, lake or the like and there is no road nearby, a direct distance can be obtained instead.

Incidentally, as for the new route passing through the cursor position, it can be generated by touching a “route setting” button in the main window of FIG. 17(b), for example. In addition, as for the prescribed information (mutual information and route information), although not shown in the general map generating unit 28 of FIG. 11, it is also possible to display fuel consumption obtained by a fuel calculating unit from the distance and fuel efficiency information on the mobile unit, or to display a charge obtained from the fuel consumption, the cost of the fuel and a fee of the toll road by a charge calculating unit. They are calculated, for example, from mutual distances between the current position of the vehicle, the destination and a spot on the route like the cursor position, or from the distance from the current position to the destination via the route.

The map display device with such a configuration can offer a navigation system with improved convenience, because it can display the information about the first route and new route when changing the route to the new route passing through the cursor position, and enable the user to grasp the information about the new guide route in advance.

### Embodiment 8

Although the embodiment 7 displays in the subwindow the general map including the route passing through the cursor position, the present embodiment 8 explains a navigation system capable of facilitating the new route setting by displaying a new route passing through a facility or spot and prescribed information about the new route on the general map.

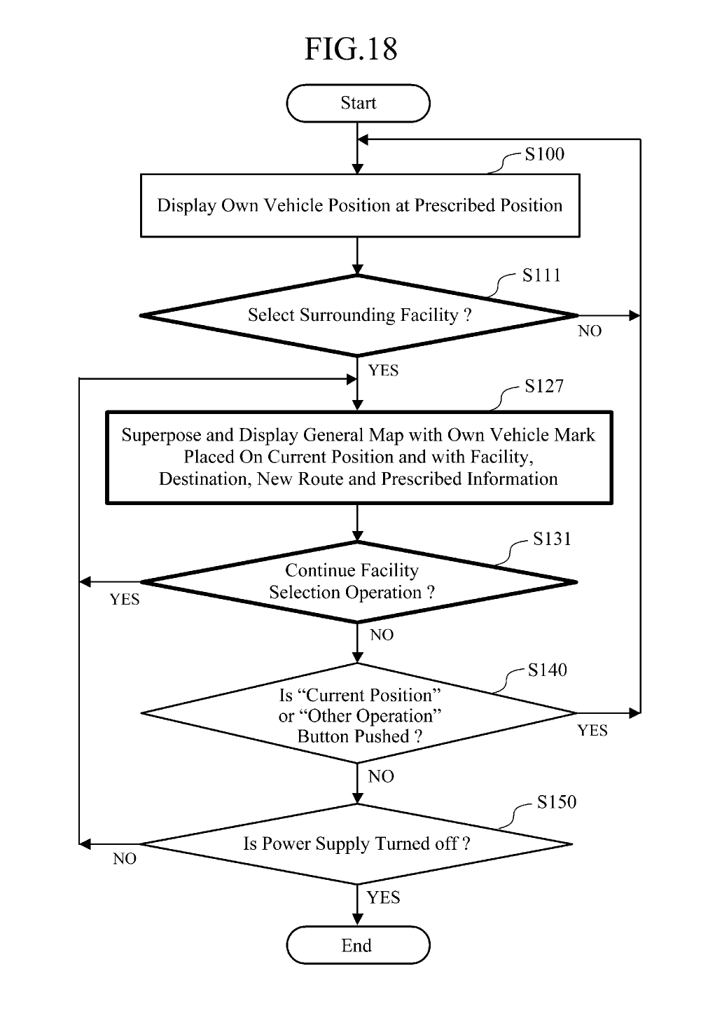

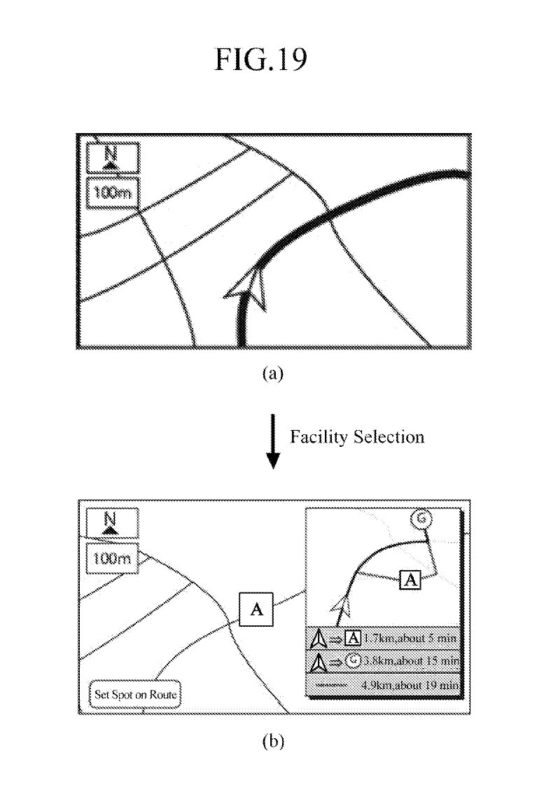

As for the system configuration, it is the same as the block diagrams of FIG. 1 and FIG. 11. FIG. 18 is a flowchart for explaining the present embodiment 8, and FIG. 19 is an example of screen display. It differs from the embodiment 7 in step S111, step S127 and step S131 in FIG. 18 and the screen display of FIG. 19(b). These differences will be described below.

The facility retrieval control unit 36 of FIG. 11 makes a decision as to whether a spot on the route such as a surrounding facility or spot is selected or not (step S111 of FIG. 18). If a surrounding facility or the like is not selected, the processing at step S100 is repeated. If a facility or the like is selected, the map in the main window changes its display as shown in FIG. 19(b) to display the facility or the like (designated by “A” in FIG. 19(b)), and the subwindow displays the general map picture including not only the vehicle mark on the current position, the facility or the like and the destination, but also the new route passing through the facility and the prescribed information about the new route (step S127 of FIG. 18).

As for the new route, the route candidate calculating unit 38 of FIG. 11 selects an actually passable road. near the position of the facility or the like and sets the new route, and the distance calculating unit 39 and the required time calculating unit 40 obtain the prescribed information from the information about the new route. In FIG. 19(b) are displayed the mutual information between the current position and the spot on the route such as a facility and between the current position and the destination (information about the distance and the time required along the route), and the route information from the current position to the destination via the spot on the route such as the facility (information about the distance and the time required along the new route).

Next, at step S131, a decision is made as to whether the selecting operation of a facility continues or not, and if the facility selection such as selecting another facility continues, the processing returns to step S127 to display the another facility selected on the general map in the subwindow. Unless it continues, the processing proceeds to step S140. As for steps S140 and S150, although they are the same as those of the embodiment 1 or embodiment 7, if the power supply is not turned off at step S150, the processing returns to step S127 to continue displaying the same facility on the general map in the subwindow.

The map display device with such a configuration enables a user to grasp the positional relationships between the current position of the vehicle and the selected facility or spot, and the information about the new route candidate passing through the selected facility or spot, thereby being able to offer a navigation system superior in convenience.

### Embodiment 9

Although the embodiment 3 displays in the subwindow the general map including the vehicle mark on the current position and the prescribed information when the scrolling is started, the present embodiment 9 explains a navigation system capable of improving visibility of the main window by displaying the general map in the subwindow when the scrolling is started and the current position of the vehicle goes out of the map display picture in the main window on the screen.

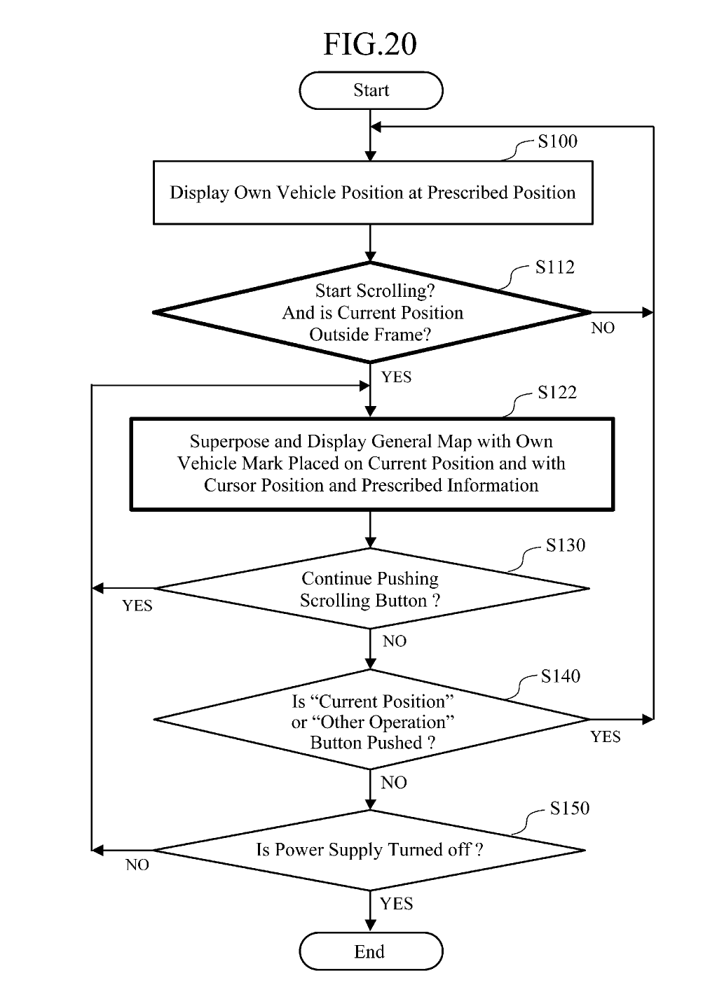

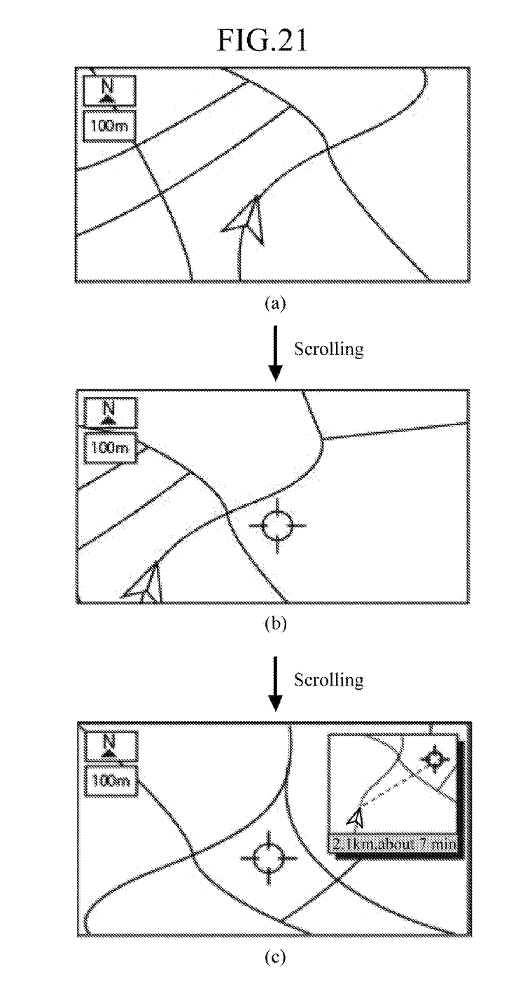

As for the system configuration, it is the same as the block diagrams of FIG. 1 and FIG. 11. FIG. 20 is a flowchart for explaining the present embodiment 9, and FIG. 21 is an example of screen display. It differs from the embodiment 3 in step S112 of FIG. 20 and the screen displays of FIGS. 21(b) and 21(c). These differences will be described below.

First, when scrolling is started and the map in the main window moves, a decision is made as to whether the vehicle mark together with the current position of the vehicle moves to the outside of the display area of the map display picture, which is the frame of the main window (step 112 of FIG. 20). When it still remains within the display area as shown in FIG. 21(b), the processing returns to step S100. When it moves outside the display area, the general map picture, which includes the vehicle mark on the current position, the cursor position and the prescribed information, is displayed in the subwindow as shown in FIG. 21(c) (step S122 in FIG. 20). The subsequent operation is the same as that of the embodiment 3.

Incidentally, as for the decision whether to start the superposition display of the subwindow or not, although the present embodiment describes it using the example of whether the current position of the vehicle moves to the outside of the display area of the map display picture, which is the frame of the main window, it is also possible to deal with a case where the current position of the vehicle leaves by a prescribed distance from the prescribed position at which it is normally displayed in the central portion of the main window or the like. In addition, the prescribed distance can be determined in accordance with the scale on which the map display picture in the main window is displayed. For example, as the map in the main window becomes broader with its scale being reduced, the prescribed distance is made shorter. Incidentally, they are obtained using the vehicle display position calculating unit 30.

In addition, although the present embodiment describes a display example in which a route is not set, this is not essential. Even if a route is set, a configuration is also possible which displays the general map in the subwindow when the scrolling is started and the current position of the vehicle moves to the outside of the map display area in the main window. In addition, when the destination is displayed in the main window, and when the destination moves to the outside of the map display area in the main window with the movement of the map in the main window, it is also possible to display the destination on the general map in the subwindow. Furthermore, when the display of the map in the main window on the screen changes owing to the display of a spot on the route or the like, it is also possible to display the general map in the subwindow when the current position or destination leaves from the prescribed position at which it is normally displayed in the main window on the screen by a prescribed distance, or moves to the outside of the display area of the map in the main window.

The map display device with such a configuration can offer a navigation system that can improve the visibility of the map display picture in the main window and is superior in convenience because when the amount of movement of the map due to scrolling or the like is small, it prevents the general map picture in the subwindow which is sometimes unnecessary from being displayed.

### Embodiment 10

Although the embodiment 5 displays, when scrolling is started, the general map including the vehicle mark, destination and cursor in the subwindow, the present embodiment 10 describes a navigation system capable of facilitating the understanding of the current position of the vehicle and the destination by displaying the general map in the subwindow when the display of the map changes because the destination is selected from the retrieval result or from a spot list registered in a memory to be displayed.

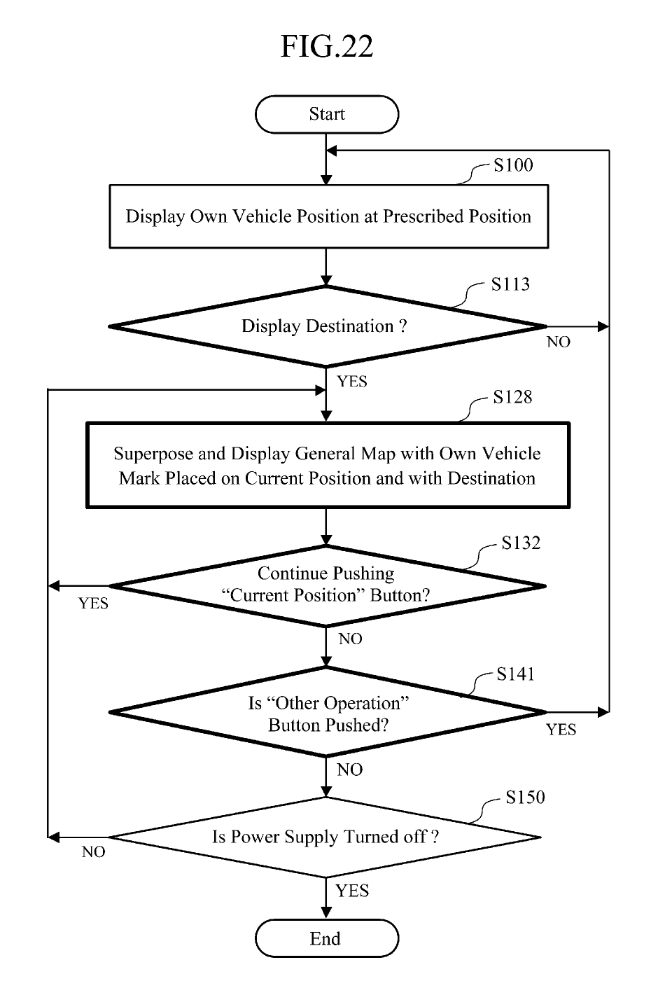

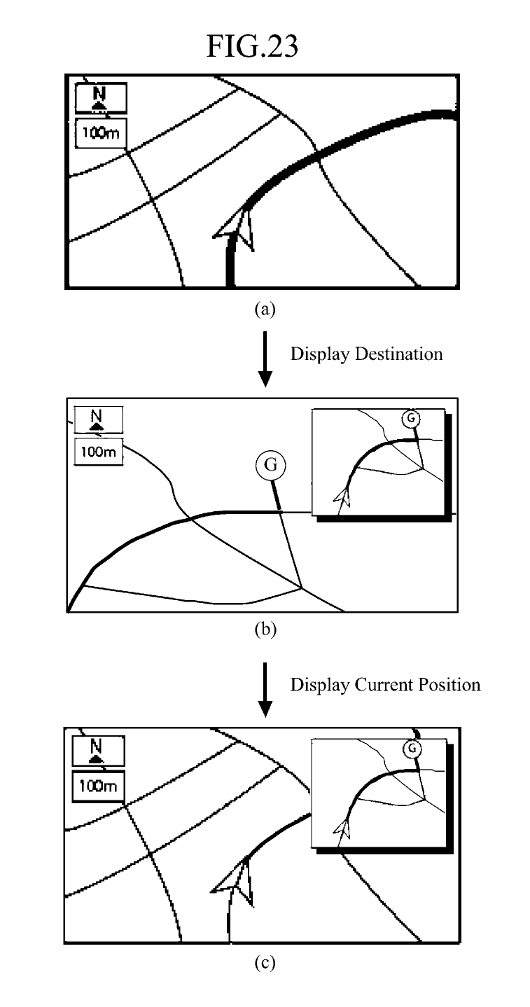

As for the system configuration, it is the same as the block diagrams of FIG. 1 and FIG. 11. FIG. 22 is a flowchart for explaining the present embodiment 10, and FIG. 23 is an example of screen display. It differs from the embodiment 5 in steps S113, S128, S132 and S141 of FIG. 22 and in the screen displays of FIGS. 23(b) and 23(c). These differences will be described below.

It selects a destination from the retrieval result or from the spot list registered in the memory, and makes a decision whether to display the destination or not (step S113 in FIG. 22). When it does not display the destination, it repeats step S100. When it selects the destination and the display on the map in the main window changes, the map display picture in the main window shows the destination as shown in FIG. 23(b), and the subwindow displays the general map picture including the vehicle mark on the current position and the destination (step S128 in FIG. 22).

Next, it makes a decision as to whether the “current position” button is pushed down or not (step S132). When the “current position” button is pushed down, it displays the current position of the vehicle on the map display picture in the main window, and returns to step S128 to continuously display the general map picture including the current position of the vehicle and destination on the subwindow as shown in FIG. 23(c). Unless the “current position” button is pushed down, it makes a decision as to whether “another operation” button such as canceling a destination setting is pushed down or not (step S141), returns, when pushed down, to step S100 to display only the map display picture in the main window (FIG. 23(a)). Unless the button is not pushed down, it makes a decision as to whether the power supply is turned off or not at step S150, and terminates the processing when turned off. Unless turned off, the processing returns to step S128 to continue the display of FIG. 23(b).

The map display device with such a configuration offers a navigation system capable of enabling a user to quickly understand the positional relationship between the two spots because it selects the spot acquired by the retrieval or registered in the memory and displays the current position of the vehicle and the destination on the general map picture in the subwindow.

### Embodiment 11

Although the embodiment 5 displays, when scrolling is started, the general map including the vehicle mark, destination and cursor in the subwindow, the present embodiment 10 describes a navigation system that enables, when demonstration running which moves the vehicle mark along a route to the destination for checking the route is started, a user to understand where the demonstration running is made over the whole distance by displaying the general map including the vehicle mark and the destination in the subwindow.

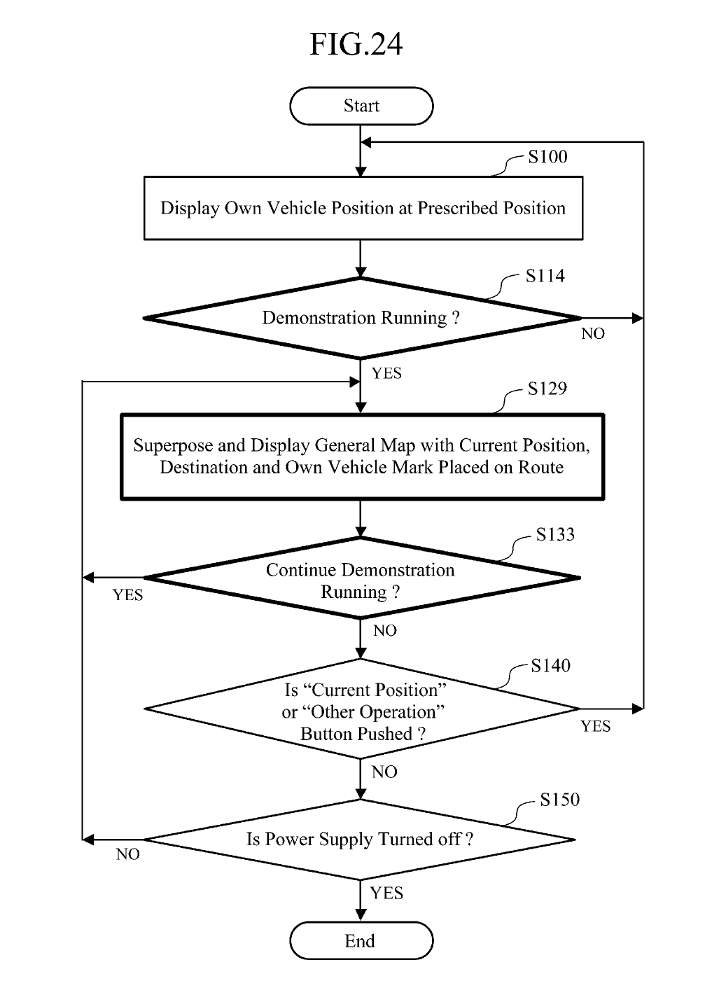

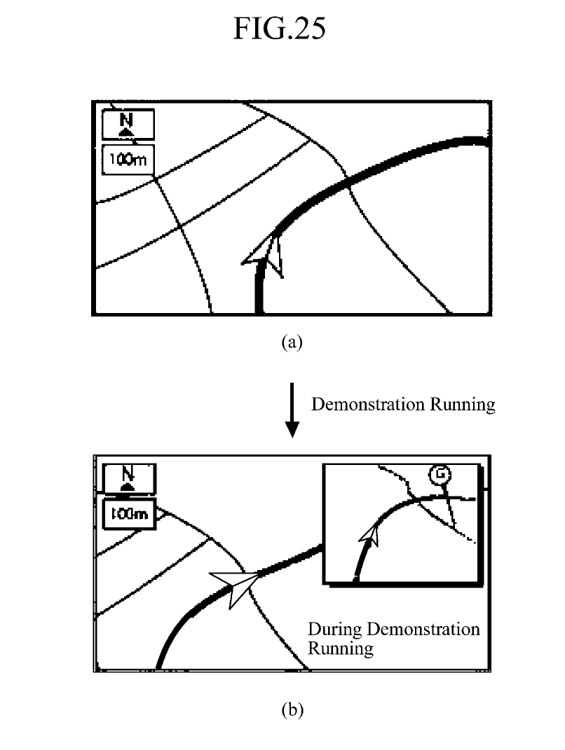

As for the system configuration, it is the same as the block diagrams of FIG. 1 and FIG. 11. FIG. 24 is a flowchart for explaining the present embodiment 11, and FIG. 25 is an example of screen display. It differs from the embodiment 5 in steps S114, S129 and S133 in FIG. 24 and in the screen display of FIG. 25. These differences will be described below.

The demonstration running is a function of carrying out a running simulation when the destination is set. It makes a decision as to whether the demonstration running is selected or not (step S114 in FIG. 24), and repeats step S100 if not selected. If selected, it enters into a demonstration running mode. In the demonstration running mode, since the vehicle mark moves along the route, the current position and the vehicle mark are displayed at different positions. More specifically, although the current position moves with the map in connection with the movement of the map in the main window, the vehicle mark is generally placed at the prescribed position in the main window on the screen, and changes only its direction with the movement of the map. As a result, as shown in FIG. 25, since the map moves while the position of the vehicle mark in the main window is maintained, the general map picture including the current position, the vehicle mark in the demonstration running on the route and the destination is displayed in the subwindow (step S129). In this case, displaying a phrase “in demonstration running” on the map display picture in the main window will facilitate the understanding that it displays the state in the demonstration running mode.

If a decision is made at step S133 that the demonstration running mode continues, step S129 is repeated. Unless the demonstration running mode continues, the processing proceeds to step S140. As for steps S140 and S150, they are the same as those of the embodiment 1 or embodiment 5. Thus, if the power supply is not turned off at step S150, the processing returns to step S129 to stop the demonstration running for a while and then to continue displaying the same map in the subwindow. After that, it can restart the demonstration running at step S133 or suspend the demonstration running at step S140.

The map display device with such a configuration can offer a convenient navigation system because it enables a user to grasp the route by carrying out the demonstration running to the destination, and to understand where the demonstration running is being made over the whole distance.

### Embodiment 12

Although the embodiments 1-11 display the general map in the subwindow at the normal map display, the present embodiment 12 describes a navigation system capable of improving the convenience by displaying the general map in the subwindow even when the vehicle is running on an expressway and the screen is divided into an information window about an interchange or the like and a map window.

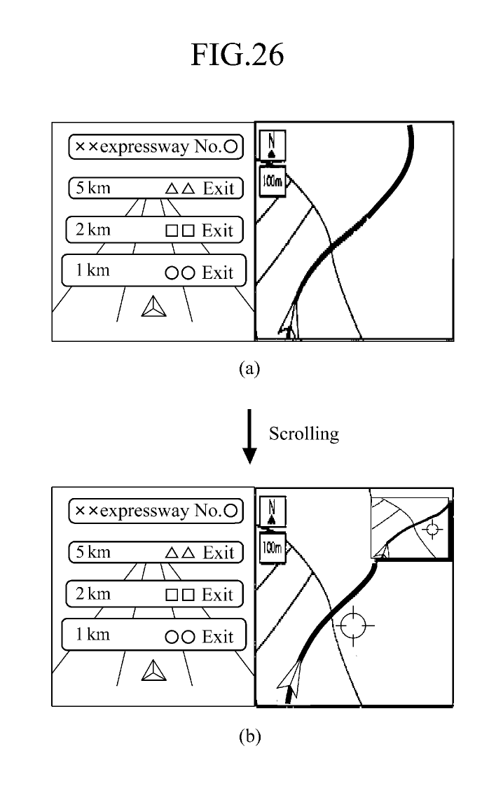

As for the system configuration, it is the same as the block diagrams of FIG. 1 and FIG. 11. FIG. 26 is an example of screen display for explaining the present embodiment 12, which relates to a display manner during expressway traveling and the like. As shown in FIG. 26(a), there are some cases where the information window about the interchange and the like and the map display picture are displayed at the same time during traveling along an expressway. In this case, as described in the embodiments 1-11, when the map in the main window moves or its display alters owing to scrolling of the map, to the demonstration running, or to the display of a destination or a spot on the route, the general map picture is superposed and displayed on the subwindow in the main window (FIG. 26(b)).

The map display device with such a configuration can offer a navigation system capable of enabling a user to grasp the relationship with the current position involved in the map movement even when the screen is divided as in the expressway traveling, thereby being able to improve the convenience.

### Embodiment 13

Although the embodiments 1-12 display the subwindow at the upper right corner, the present embodiment 13 describes a navigation system capable of improving the visibility by displaying the general map in the subwindow taking account of a scrolling direction.

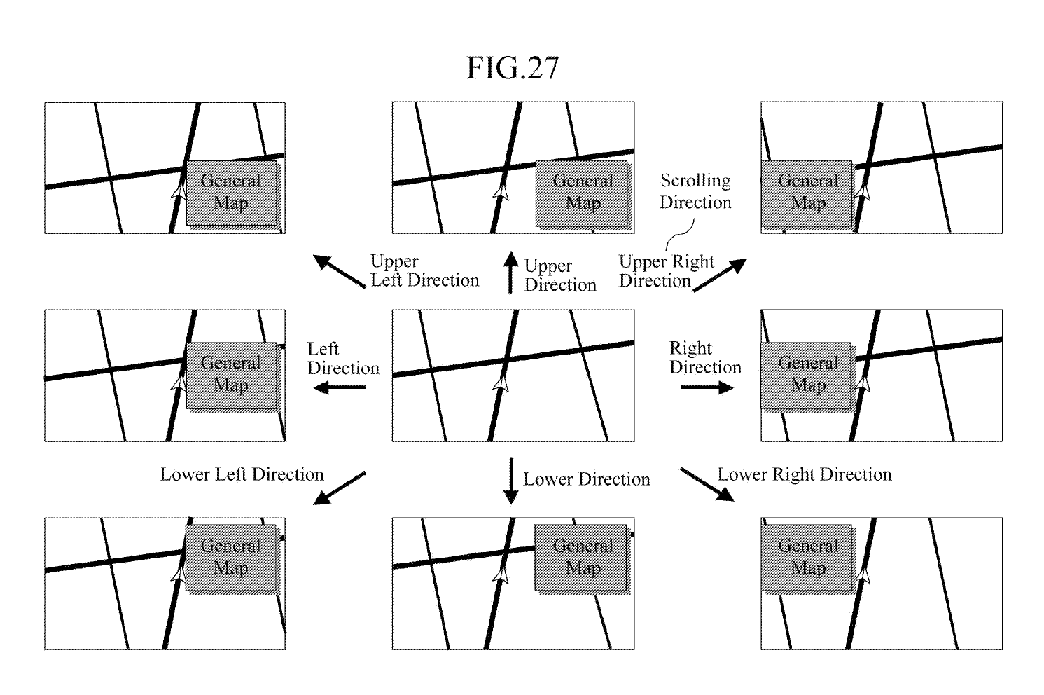

As for the system configuration, it is the same as the block diagrams of FIG. 1 and FIG. 11. FIG. 27 is an example of screen display for explaining the present embodiment 13, which relates to a display position of the general map picture in the subwindow to be superposed and displayed on the map display picture in the main window. As shown in FIG. 27, when scrolling is started and the map in the main window moves, the general map picture in the subwindow is superposed and displayed on an area in the direction opposite to the scrolling direction.

Incidentally, although the subwindow is displayed in the direction opposite to the scrolling, it can be displayed in the same direction.

The navigation system with such a configuration can offer a navigation system superior in visibility because the general map picture in the subwindow to be superposed and displayed is placed in the direction opposite to the scrolling direction of the map display picture in the main window, and hence it does not usually interfere with a map a user wishes to see. In addition, when displaying the subwindow in the same direction as the scrolling direction, the subwindow placed in the scrolling direction displays a reduced map, which enables checking a wider area in the subwindow and facilitates the understanding of the whole image, thereby improving the convenience.

### Embodiment 14

Although the embodiments 1-13 superpose and display the general map in the subwindow on the map display picture in the main window, the present embodiment 14 describes a navigation system capable of improving the visibility by altering a mode of displaying the general map on the map display picture.

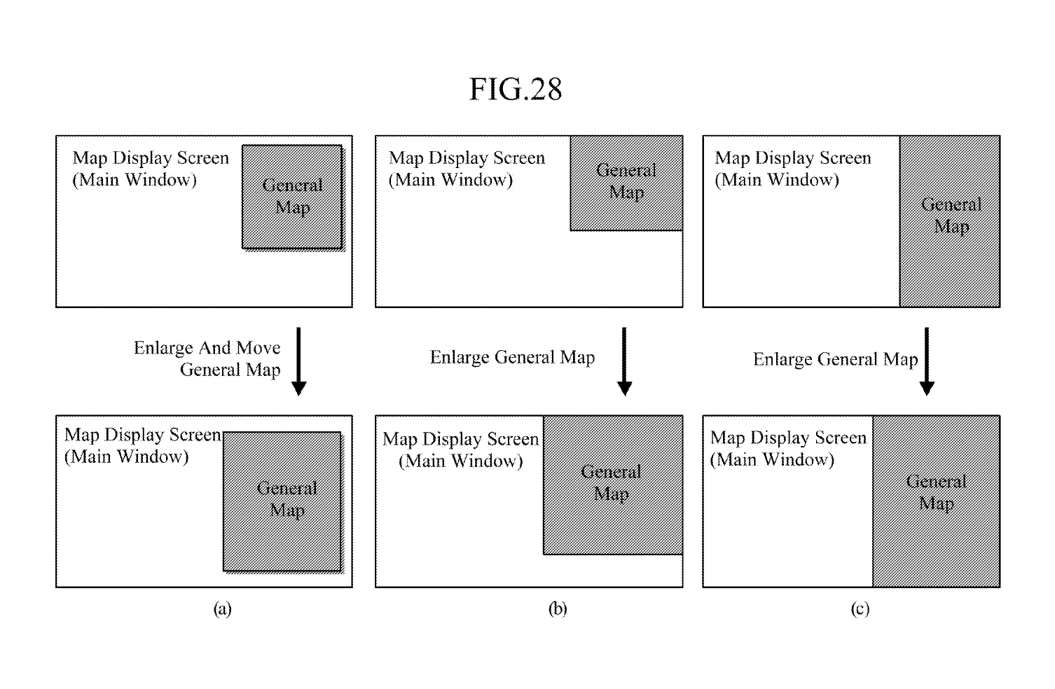

As for the system configuration, it is the same as the block diagrams of FIG. 1 and FIG. 11. FIG. 28 is an example of screen display for explaining the present embodiment 14, which relates to the size and display position of the general map picture in the subwindow to be displayed on the map display picture in the main window simultaneously. Incidentally, the size and display position of the general map picture in the subwindow are made changeable here. FIGS. 28(a)-28(c) show examples of screen display.

FIG. 28(a) shows an example that superposes and displays the subwindow on any desired place in the main window, in which the position, size and movement of the area of the window can be properly determined. FIG. 28(b) is an example of a PinP (Picture in Picture), in which the subwindow is displayed at a corner of the main window in an appropriate size. Incidentally, in FIG. 28(b), although the upper right picture is enlarged at the upper right position without changing the position, it can be moved to any other corner on the screen. FIG. 28(c) show an example of screen division. In FIG. 28(c), although the right side picture is also enlarged at the right side without changing the position, it can be moved to any other place. Combining them properly makes it possible not to interfere with the display of the main window.

The map display device with such a configuration can offer a navigation system superior in visibility because it can prevent the general map picture in the subwindow from interfering with the map display picture in the main window.

### INDUSTRIAL APPLICABILITY

A navigation system in accordance with the present invention displays a general map including the current position and vehicle mark when a map on a screen is moved in response to an operation of a user. Accordingly, it is suitable for an application to a navigation system or the like, which is mounted in a mobile unit for displaying a map or for guiding to a destination.

1-32. (canceled)

33. A navigation system comprising:
a vehicle position determining unit for determining a current position of a mobile unit;
a map database that stores map data;
a display unit for displaying on its screen the map data and a vehicle mark indicating the current position of the mobile unit on the map;
an operation input unit for inputting operation of a user;
a route searching unit for searching for a route to a destination or a route to the destination via a spot on the route; and
a map generating unit for reading the map data from the map database, for generating a general map that includes the vehicle mark and a cursor position of scrolling and that has a smaller scale than the map on the screen, and for displaying the general map on the display unit as a partial area in the screen, when display of the map on the screen alters in response to operation information from the operation input unit.

34. The navigation system according to claim 33, wherein
the map generating unit creates the general map when the display of the map on the screen alters owing to display of the destination or display of the spot on the route in response to the operation information from the operation input unit.

35. The navigation system according to claim 33, wherein
the map generating unit creates the general map when the display of the map on the screen alters in response to the operation information from the operation input unit and the current position on the map moves away from a prescribed position on the screen by a prescribed distance, or when the current position or the destination on the map moves outside a display area of the map on the screen.

36. The navigation system according to claim 33, wherein
the general map is a map that has the same scale but has a smaller amount of information than the general map.

37. The navigation system according to claim 33, wherein
the map generating unit alters an amount of information of the general map in accordance with a scale of the general map.

38. The navigation system according to claim 33, wherein
the map generating unit displays the general map at a corner of the screen, displays it by dividing the screen, or displays it by superposing on the map on the screen.

39. The navigation system according to claim 33, wherein
the map generating unit forms the general map in accordance with a moving direction of the map on the screen.

40. The navigation system according to claim 33, wherein
the map generating unit displays on the general map at least one of the destination, the spot on the route, and a cursor position indicating a position of scrolling.

41. The navigation system according to claim 33, wherein
the map generating unit displays on the general map at least one of the route and a prescribed object on the route.

42. The navigation system according to claim 41, wherein
the prescribed object is an intersection at which the route turns, a spot at which a number of lanes changes on the route or a spot whose distance from the route is less than a prescribed value.

43. The navigation system according to claim 40, wherein
the general map shows mutual information between at least a pair of the current position, the destination, and the spot on the route.

44. The navigation system according to claim 40, wherein
the general map shows mutual information between at least a pair of the current position, the destination, and the cursor position or a spot whose distance from the cursor position is less than a prescribed value.

45. The navigation system according to claim 40, wherein
the general map shows route information from the current position to the destination via the spot on the route or the cursor position or a spot whose distance from the cursor position is within a prescribed distance.

46. The navigation system according to claim 43, wherein
the mutual information or the route information is at least one of the distance, time, a charge and fuel consumption.

47. The navigation system according to claim 44, wherein
the mutual information or the route information is at least one of the distance, time, a charge and fuel consumption.

48. The navigation system according to claim 45, wherein
the mutual information or the route information is at least one of the distance, time, a charge and fuel consumption.
